(19) United States
(12) Patent Application Publication
(10) Pub. No.: US 2009/0295329 A1
(43) Pub. Date: Dec. 3, 2009

(54) VEHICLE POWER SUPPLY DEVICE

(76) Inventor: Masaki YUGOU, Kakogawa City (JP)

Correspondence Address: WENDEROTH, LIND & PONACK, L.L.P., 1030 15th Street, N.W.,, Suite 400 East, Washington, DC, 20005-1503, US

(21) Appl. No.: 12/472,643

(22) Filed: May 27, 2009

(30) Foreign Application Priority Data
May 29, 2008 (JP) 2008-141703

(51) Int. Cl. H02J 7/00

(52) U.S. Cl. 320/116

(57) ABSTRACT

The vehicle power supply device includes a high-voltage battery portion 1 that includes a plurality of serially-connected rechargeable batteries, a current detecting portion 3 that detects the current of the battery portion 1, a voltage detecting circuit 4 that detects the voltage of the battery portion 1, and a power supply circuit 5 that supplies power to power supply lines 20 of the voltage detecting circuit 4 and the current detecting portion 3. The current detecting portion 3 includes a shunt resistor 7 serially connected to the batteries, and a current detecting circuit 6 for detecting the current based on the voltage between the ends of the shunt resistor 7. The power supply circuit 5 is an insulated-type power supply circuit 5A insulated from a vehicle chassis ground. The power supply circuit 5A supplies power to the power supply lines 20.

### BACKGROUND OF THE INVENTION

1. Field of the Invention

The present invention relates to a vehicle power supply device that includes a high-voltage battery portion for supplying power to electric motors to run vehicles, and in particular to a vehicle power supply device that includes a circuit for detecting detects the voltage and the current of the batteries composing a high-voltage battery portion.

2. Description of the Related Art

Vehicle power supply devices that are installed in electric vehicles such as hybrid cars include a high-power high-voltage battery portion. This type of power supply device supplies power to an electric motor of a vehicle from a high-voltage battery portion to run the vehicle by the electric motor. In hybrid cars, vehicles run both by an electric motor driven by a power supply device, and by an internal-combustion engine. The hybrid cars drive an electric generator by the internal-combustion engine to charge a high-voltage battery portion, or charge the high-voltage battery portion by regenerative braking of the vehicles. Also, the vehicles run by discharging the high-voltage battery portion to the electric motor. This type of power supply device detects the voltage and the current of the high-voltage battery portion, and controls charging/discharging currents so that the battery portion is protected in charging/discharging operation (see Japanese Laid-Open Patent Publication No. JP 2004-120966A). The reason is to suppress deterioration of the high-voltage battery portion as small as possible to improve the life of the battery portion. The high-voltage battery portion includes a number of batteries that are connected in series to increase the output voltage of the battery portion. Accordingly, a voltage detecting circuit detects the voltage of each battery, or the voltage of a battery module that is composed of a plurality of serially-connected batteries. To prevent problems such as an electric shock and improve safety, the high-voltage battery portion is not connected to a vehicle chassis ground and is insulated from the chassis ground. Thus, the voltage detecting circuit that detects the voltage of the batteries in the high-voltage battery portion is not connected to the vehicle chassis ground and is insulated from the chassis ground. For this reason, an insulated-type power supply circuit that is insulated from the chassis ground is used as a power supply circuit that supplies power to a power supply line of the voltage detecting circuit.

Also, a current sensor of a Hall effect device is used as a current detecting portion that detects the current of the high-voltage battery portion. Since this type of current sensor detects a current based on a magnetic flux that is generated by the current, the current sensor can detect the current with being insulated from the high-voltage portion. Accordingly, in the current detecting circuit that detects the current based on the output of this type of current sensor, electric power is supplied to the power supply line from the non-insulated-type power supply circuit that is connected to the vehicle chassis ground. Thus, the power supply device that detects the voltage and the current of the high-voltage battery portion includes the insulated-type power supply circuit and the non-insulated-type power supply circuit Power is supplied from the insulated-type power supply circuit to the voltage detecting circuit, and from non-insulated-type power supply circuit to the current detecting circuit. For this reason, there is a disadvantage in that the power supply circuit is complicated. In addition, there is a disadvantage in that hysteresis makes it difficult to accurately detect the current by the current sensor that detects the current of the high-voltage battery portion based on the magnetic flux.

### SUMMARY OF THE INVENTION

The present invention has been developed for solving the aforementioned disadvantages. It is an important object of the present invention to provide a vehicle power supply device that has a simple configuration capable of detecting both the voltage and the current of a high-voltage battery portion by using power supplied from an insulated-type power supply circuit, and can accurately detect the current of the high-voltage battery portion.

To achieve the aforementioned object, a vehicle power supply device according to the present invention is configured as follows.

The vehicle power supply device includes a high-voltage battery portion 1 that includes a plurality of serially-connected rechargeable batteries, a current detecting portion 3, 33, 53 or 93 that detects the current of the high-voltage battery portion 1, a voltage detecting circuit 4, 34, 54 or 94 that detects the voltage of the high-voltage battery portion 1, and a power supply circuit 5 that supplies power to power supply lines of the voltage detecting circuit 4, 34, 54 or 94 and the current detecting portion 3, 33, 53 or 93. The current detecting portion 3, 33, 53 or 93 includes a shunt resistor 7 that is serially connected to the batteries, and a current detecting circuit 6, 36, 56 or 96 that detects the current based on the voltage between the both ends of the shunt resistor 7. The power supply circuit 5 is an insulated-type power supply circuit 5A that is insulated from a vehicle chassis ground and supplies power. The insulated-type power supply circuit 5A supplies the power to the power supply lines 20 of both the current detecting circuit 6, 36, 56 or 96 and the voltage detecting circuit 4, 34; 54 or 94.

According to the thus-configured power supply device, it is not necessary to use an insulated-type power supply circuit and a non-insulated-type power supply circuit to detect the voltage and the current of a high-voltage battery portion as in the case of conventional power supply devices. The aforementioned power supply device can detect both the voltage and the current of the high-voltage battery portion by supplying power from the insulated-type power supply circuit that is insulated from the vehicle chassis ground. Therefore, the aforementioned power supply device has a feature in that its circuit configuration can be simplified but the device can accurately detect the current of the high-voltage battery portion by the circuit that detects the voltage generated between the both ends of the shunt resistor.

In the vehicle power supply device according to another aspect of the present invention, the high-voltage battery portion 1 can be insulated from the chassis ground, and can include two battery blocks 1A and 1B that are connected on the positive and negative sides with respect to a ground line 21 connected to an earth line 22 of the insulated-type power supply circuit 5A, and the shunt resistor 7 can be serially connected to a point in proximity to the ground line 21.

It should be appreciated that, in this specification, a shunt resistor that is serially connected to the “point in proximity to the ground line” refers not only to a shunt resistor that is directly connected to the ground line but to a shunt resistor that is connected between the ground line and batteries the number of which is not more than one tenth the number of total batteries that compose the battery block.

According to the thus-configured power supply device, it is possible to accurately detect the voltage of the shunt resistor, and to detect the current of the high-voltage battery portion with higher accuracy. The reason is that, in the case where the shunt resistor that is serially connected to a point in proximity to the ground line, the voltage that is generated between the both ends of the shunt resistor does not become high with respect to the ground line. If the voltage of the shunt resistor is high with respect to the ground line, it is necessary to obtain a fraction of the generated voltage by a voltage dividing circuit and then to provide the fraction of the generated voltage to the current detecting circuit. A deviation by the voltage dividing circuit may reduce the accuracy of detected current. Since, in the case where the shunt resistor is connected to a point in proximity to the ground line, the voltage of the shunt resistor can be directly detected without obtaining a fraction of the voltage by a voltage dividing circuit, it is possible to provide highly accurate detection. The reason is that detection accuracy is not affected by a deviation by a voltage dividing circuit, and reduction of a detected voltage by a voltage dividing circuit.

In the vehicle power supply device according to another aspect of the present invention, the device further can include a fuse 8 that is serially connected to the high-voltage battery portion 1. In this device, the high-voltage battery portion 1 can be insulated from the chassis ground, and can include two battery blocks 1A and 1B that are connected on the positive and negative sides with respect to a ground line 21 connected to an earth line 22 of the insulated-type power supply circuit 5A, and the fuse 8 can be serially connected to a point in proximity to the ground line 21.

Also, in the vehicle power supply device according to another aspect of the present invention, the device further can include a fuse 8 that is serially connected to the high-voltage battery portion 1. In this device, the high-voltage battery portion 1 can be insulated from the chassis ground, and can include two battery blocks 1A and 1B that are connected on the positive and negative sides with respect to a ground line 21 connected to an earth line 22 of the insulated-type power supply circuit 5A, and the fuse 8 and the shunt resistor 7 can be serially connected to a point in proximity to the ground line 21.

In the vehicle power supply device according to another aspect of the present invention, the voltage detecting circuit 34 or 94 can include a multiplexer 40 that includes a plurality of input terminals 40a connected to the plurality of batteries, and provides switching of the input terminals 40a at a predetermined sampling period to detect the voltages of the batteries, and an A/D converter 11 that converts analog signals provided from the multiplexer 40 into digital signals and provides the voltages of the batteries represented by the digital signals. In this device, the channel number of input terminals 40a of the multiplexer 40 can be greater than the number of the input terminals 40a that detects the voltages of the batteries. Also, in this device, the shunt resistor 7 can be connected to one of the input terminals 40a of the multiplexer 40. In addition, in this device, the multiplexer 40 can provide switching of the input terminals 40a that are connected to the batteries and the shunt resistor 7 to provide the voltages of the batteries and the voltage of the shunt resistor 7 to the A/D converter 11 so that the voltages and the currents of the batteries can be detected based on the outputs of the A/D converter 11.

According to the thus-configured power supply device, without using a circuit dedicated to detection of the voltage of the shunt resistor, it is possible to detect the voltage of the shunt resistor, i.e., the current of the high-voltage battery portion by using a circuit that detects the voltage of the high-voltage battery portion as a circuit that detects the voltage of the shunt resistor. In particular, in this power supply device, the voltage of the shunt resistor is provided to one input terminal of the multiplexer. Accordingly, it is necessary to provide one additional channel as compared with a multiplexer that detects only the battery voltages of a high-voltage battery portion. However, a circuit can be configured very easily that includes a multiplexer with one additional channel. Actually, multiplexers are often used without using all their input terminals. The reason is that, since standardized multiplexers are used, generally, the number of channels is greater than the number of battery voltages to be detected. In the case where a multiplexer has a redundant input terminal that is not used, and the voltage of the shunt resistor is provided to the redundant terminal, this power supply device has a feature in that the current of the high-voltage battery portion can be detected with high accuracy by a further simplified circuit configuration.

In the vehicle power supply device according to still another aspect of the present invention, the device can further include a secondary voltage detecting circuit 57 that detects the voltages between the both ends of the fuse 8 and between the both ends of the shunt resistor 7, and a fault monitoring circuit 58 that monitors fault of the fuse 8 and the shunt resistor 7 based on the voltages detected by the secondary voltage detecting circuit 57. In this device, the secondary voltage detecting circuit 57 can detect a fraction of one of the voltages generated between the both ends of the fuse 8 and between the both ends of the shunt resistor 7, and the fault monitoring circuit 58 can monitor fault of the fuse 8 and the shunt resistor 7 based on the detected fraction of the voltage.

According to the thus-configures power supply device, fault of the fuse and the shunt resistor can be detected. Therefore, this power supply device has a feature in that it is possible to determine whether the detected current is accurate and to reliably detect the current of the high-voltage battery portion.

The above and further objects of the present invention as well as the features thereof will become more apparent from the following detailed description to be made in conjunction with the accompanying drawings.

### BRIEF DESCRIPTION OF THE DRAWINGS

FIG. 1 is a view schematically showing a vehicle power supply device according to an embodiment of the present invention;

FIG. 2 is a view schematically showing a vehicle power supply device according to another embodiment of the present invention;

FIG. 3 is a view schematically showing a vehicle power supply device according to another embodiment of the present invention;

FIG. 4 is a view showing the vehicle power supply device shown in FIG. 3 with a fuse being disconnected;

FIG. 5 is a view showing the vehicle power supply device shown in FIG. 3 with a shunt resistor being disconnected;

FIG. 6 is a flowchart of a fault monitoring circuit that monitors fault of the shunt resistor and the fuse; and

FIG. 7 is a view schematically showing a vehicle power supply device according to still another embodiment of the present invention.

### DETAILED DESCRIPTION OF THE EMBODIMENT(S)

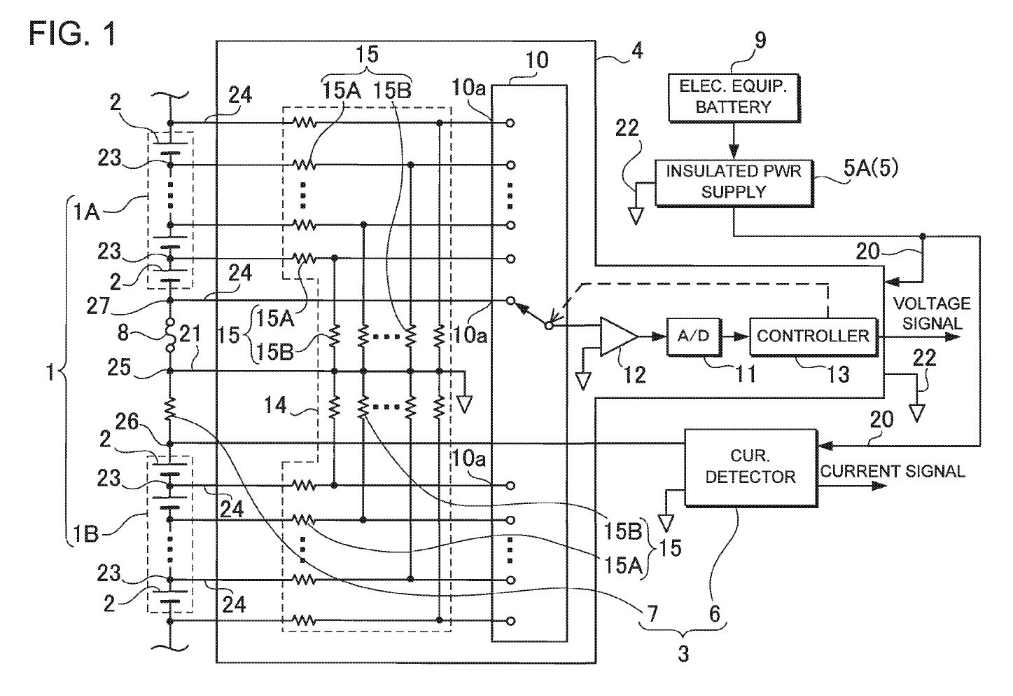

The vehicle power supply devices shown in FIGS. 1 through 3 include a high-voltage battery portion 1, a current detecting portion 3, 33 or 53, a voltage detecting circuit 4, 34 or 54, and a power supply circuit 5. The high-voltage battery portion 1 includes a plurality of serially-connected rechargeable batteries. The current detecting portion 3, 33 or 53 detects the current of the high-voltage battery portion 1. The voltage detecting circuit 4, 34 or 54 detects the voltage of the high-voltage battery portion 1. The power supply circuit 5 supplies power to power supply lines 20 of the voltage detecting circuit 4, 34 or 54 and the current detecting portion 3, 33 or 53. The current detecting portion 3, 33 or 53 includes a shunt resistor 7, and a current detecting circuit 6, 36 or 56. The shunt resistor 7 is serially connected to the batteries. The current detecting circuit 6, 36 or 56 detects the current based on the voltage between the both ends of the shunt resistor 7. The power supply circuit 5 is an insulated-type power supply circuit 5A that is insulated from a vehicle chassis ground and supplies power. The insulated-type power supply circuit 5A supplies the power to the power supply lines 20 of both the current detecting circuit 6, 36 or 56 and the voltage detecting circuit 4, 34 or 54.

The voltage detecting circuit 4, 34 or 54 detects the voltage of the high-voltage battery portion 1, and controls charging/discharging operation of the high-voltage battery portion 1 based on the detected voltage. The high-voltage battery portion 1 includes a plurality of battery modules 2 that are connected to each other in sires. Each of the battery modules 2 includes two or more of the serially-connected batteries. In this power supply device, the voltage detecting circuit 4, 34 or 54 detects the voltage of each of the battery modules 2, and the total voltage of the high-voltage battery portion 1. The voltage detecting circuit 4, 34 or 54 detects the voltages of the nodes of the high-voltage battery portion 1 with the plurality of serially-connected batteries, and the total voltage of the high-voltage battery portion 1.

In the power supply device in that the high-voltage battery portion 1 includes the plurality of battery modules 2 each of which is composed of two or more of the serially-connected rechargeable batteries, the voltage detecting circuit 4, 34 or 54 detects the voltage of each battery module 2. It should be appreciated that, in the case where the power supply device according to the present invention includes a high-voltage battery portion that includes a plurality of serially-connected batteries that do not compose the battery module, the voltage detecting circuit can detect the voltage of each battery. In the power supply device that includes the high-voltage battery portion 1 with the serially-connected battery modules 2, the nodes of the battery modules 2 as voltage detecting points 23 are connected to the voltage detecting circuit 4, 34 or 54. The voltage detecting point 23 refers to a node for detecting the voltage of the battery module or the battery by means of the voltage detecting circuit. It should be appreciated that, although not illustrated, a plurality of battery modules can compose one unit, and the voltage detecting circuit can detect the voltage of each unit. For example, in the case where the high-voltage battery portion includes fifty serially-connected battery modules, the voltage detecting circuit preferably detects the voltage of each of all the fifty battery modules. Alternatively, two of the battery modules can compose one unit, and the voltage detecting circuit can detect the total voltage of two battery modules as a unit voltage.

The detected voltages of the battery modules 2 can be used to detect the remaining capacities of the battery modules 2. The detected voltages of the battery modules 2 can be also used to correct a remaining capacity that is calculated by integrating charging/discharging currents. The detected voltages of the battery modules 2 can be also used to cut off a discharging current when it is detected that the remaining capacity becomes zero, and that the battery modules 2 are fully discharged and are brought to an over-discharged state. The detected voltages of the battery modules 2 can be also used to cut off a charging current when it is detected that the battery modules 2 are fully charged and are brought to an over-charged state.

In the high-voltage battery portion 1 that includes a number of the battery modules 2 that are serially connected to each other, the battery modules 2 are charged/discharged at the same current. Accordingly, the amounts of charging and discharging currents will be the same for all the battery modules 2. However, the electric characteristics of all the battery modules 2 do not always equally vary. In particular, in the case where the number of repetitive charging/discharging cycles increases, the deterioration degrees of the battery modules 2 are different. For this reason, the fully-charged capacities of the battery modules 2 differently vary. In this case, the battery module 2 with a reduced fully-charged capacity becomes likely to be over-charged and over-discharged. If over-charged or over-discharged, the electric characteristics of the battery module 2 remarkably deteriorate. A battery module 2 with a reduced fully-charged capacity may sharply deteriorate when over-charged or over-discharged. For this reason, in the high-voltage battery portion 1 that includes a number of the battery modules 2 that are serially connected to each other, it is important to prevent all the battery modules 2 from being over-charged and over-discharged, in other words, to protect the battery modules 2 in charging/discharging operation. In order to protect all the battery modules 2 in charging/discharging operation, the voltage detecting circuit 4 detects the voltages of the battery modules 2.

Each of the battery modules 2 includes five nickel-hydrogen batteries that are serially connected to each other, for example. In the case where the fifty battery modules 2 are serially connected, total 250 nickel-hydrogen batteries are serially connected. In this case, the output of the power supply device will be 300 V. The battery module 2 does not necessarily include five serially-connected batteries, but can include four or less, or six or more of serially-connected rechargeable batteries, for example. The high-voltage battery portion does not necessarily include fifty serially-connected battery modules, but can include less than or more than fifty serially-connected battery modules. Other rechargeable batteries such as lithium-ion rechargeable and nickel-cadmium batteries can be used as the rechargeable batteries that compose the battery module.

In the power supply device shown FIGS. 1 through 3, the high-voltage battery portion 1 is divided into two battery blocks 1A and 1B. The battery blocks 1A and 1B are serially connected to each other on the positive and negative sides with respect to a ground line 21 that is insulated from the chassis ground. The voltage detecting circuit 4, 34 or 54 detects battery voltages of the battery blocks 1A and 1B. For example, in the case where the high-voltage battery portion totally includes fifty serially-connected battery modules, the high-voltage battery portion can be divided into two battery blocks so that a first battery block includes twenty five serially-connected battery modules, and a second battery block includes twenty five serially-connected battery modules. Alternatively, the high-voltage battery portion can be divided into two battery blocks so that the two battery blocks include different numbers of serially-connected battery modules. For example, the first battery block can include twenty four serially-connected battery modules, and the second battery block can include twenty six battery modules.

In the voltage detecting circuit 4, 34 or 54, the multiplexer 10, 40 or 60 is connected on the input side. The multiplexer 10, 40 or 60 provides switching at a predetermined sampling period to detect the voltages of the batteries. The voltage detecting circuit 4, 34 or 54 detects the voltages at the voltage detecting points 23 with respect to the ground line 21, and calculates the voltages of the battery modules 2 based on the voltage difference of the detected voltage detecting points 23. The ground line 21 of the high-voltage battery portion 1 is connected to earth lines 22 of the voltage detecting circuit 4, 34 or 54 and the insulated-type power supply circuit 5A. The earth line 22 of the voltage detecting circuit 4, 34 or 54 is not connected to the vehicle chassis ground. The reason is to prevent an electric shock.

The voltage detecting points 23 as the nodes of the battery modules 2 are connected to the voltage detecting circuit 4, 34 or 54 via voltage detection lines 24. The voltage detecting circuit 4, 34 or 54 detects the voltages of the voltage detecting points 23 to detect the voltages of the battery modules 2.

The voltage detecting circuit 4, 34 or 54 includes the multiplexer 10, 40 or 60 on the input side. The output of the multiplexer 10, 40 or 60 is provided to an A/D converter 11. The multiplexer 10, 40 or 60 provides switching of a plurality of input terminals 10a, 40a or 60a at the predetermined sampling period, and provides the output of the multiplexer 10, 40 or 60 to the AD converter 11. The input terminals 10a, 40a or 60a are connected to the respective voltage detecting points 23 as the nodes of the battery modules 2. The output of the multiplexer 10, 40 or 60 is provided to the A/D converter 11 via a buffer amplifier 12. The A/D converter 11 converts the detected voltages into digital signals, and provides the digital signals to a control circuit 13. The control circuit 13 provides the detected voltages as voltage signals.

Also, the voltage detecting circuit 4, 34 or 54 includes a resistor voltage dividing circuit 14 on the input side of the multiplexer 10, 40 or 60. The resistor voltage dividing circuit 14 provides a fraction of the voltage of each voltage detecting point 23 to the multiplexer 10, 40 or 60. The highest voltage of the voltage detecting point 23 is several hundreds volts, and is higher than the maximum input voltage for the multiplexer 10, 40 or 60. In the case where the power supply voltage of the multiplexer 10, 40 or 60 is 5 to 10 V, the maximum input voltage of the multiplexer 10, 40 or 60 is required lower than the power supply voltage for the multiplexer 10, 40 or 60. The resistor voltage dividing circuit 14 divides the voltage of the voltage detecting point 23 at a certain voltage dividing ratio to provide a fraction of the voltage. The voltage dividing ratio of the resistor voltage dividing circuit 14 is specified by the electrical resistances of resistors 15 that are serially connected to each other. In the case where, as compared with a parallel resistor 15B that is connected to the input side of the multiplexer 10, 40 or 60 in parallel, the electrical resistance of a series resistor 15A is large that is connected to the input side of the multiplexer 10, 40 or 60 in series, the voltage dividing ratio of the resistor voltage dividing circuit 14 can be large, in other words, an input voltage of the multiplexer 10, 40 or 60 can small. In a series circuit of the resistors 15 that compose the resistor voltage dividing circuit 14, in order to reduce power consumption of the batteries, detecting currents that flow in this circuit are very small, for example, not more than 100 μA, preferably not more than 50 μA.

The resistor voltage dividing circuit 14 provides a fraction of the voltage of the voltage detecting point 23 to drop the voltage to several volts. The fraction of the voltage is then provided to the multiplexer 10, 40 or 60. The ratio between the resistors 15 that are serially connected to each other specifies the fraction of the voltage of the voltage detecting point 23 that is obtained by the voltage dividing circuit 14. The fraction of the voltage that is obtained by the resistor voltage dividing circuit 14 is provided to the AD converter 11 via the multiplexer 10, 40 or 60 and the buffer amplifier 12. The fraction of the voltage is converted into a digital signal by the A/D converter 11, and is then provided to the control circuit 13. The control circuit 13 converts the fraction of the voltage into an actual voltage in consideration of the fraction of the resistor voltage dividing circuit 14, and calculates the voltage of the battery module 2. For example, in the case where the fraction of a voltage that is obtained by the resistor voltage dividing circuit 14 is 1/100, the control circuit 13 multiplies the detected voltage by 100 to convert the detected voltage into the voltage of the voltage detecting point 23. The voltage detecting circuit 4, 34 or 54 detects a voltage difference between the nodes that are connected to the both ends of the battery module 2 as the voltage of the battery module 2. Also, the voltage detecting circuit 4, 34 or 54 detects the total voltage based on a voltage difference between the negative and positive sides.

The voltage detecting circuit 4, 34 or 54 is not connected to the chassis ground on the output side. That is, the voltage detecting circuit 4, 34 or 54 is operated by power that is supplied via the insulated-type power supply circuit 5A that is insulated from the chassis ground. The insulated-type power supply circuit 5A includes a transformer. The insulated-type power supply circuit 5A supplies power that is supplied from an electrical equipment battery 9 to the power supply lines 20 of the voltage detecting circuit 4, 34 or 54 insulated through the transformer. Also, the insulated-type power supply circuit 5A stabilizes the voltage of the electrical equipment battery 9, and supplies the stabilized power to the power supply line 20 of the voltage detecting circuit 4, 34 or 54. It should be appreciated that the insulated-type power supply circuit can be a circuit that supplies power from the high-voltage battery portion instead of the electrical equipment battery.

In the power supply devices shown in FIGS. 1 through 3, the two battery blocks 1A and 1B are serially connected to each other via a fuse 8 and the shunt resistor 7. A node 25 between the fuse 8 and the shunt resistor 7 is connected to the ground line 21. In the case where the battery blocks 1A and 1B are serially connected to each other via the fuse 8 and the shunt resistor 7, one battery block 1A is connected to the ground line 21 via the fuse 8, and the other battery block 1B is connected to the ground line 21 via the shunt resistor 7. In the illustrated power supply device, the fuse 8 is connected on the positive side with respect to the ground line 21, and the shunt resistor 7 is connected on the negative side with respect to the ground line 21. Although not illustrated, the fuse may be connected on the negative side with respect to the ground line, and the shunt resistor may be connected on the positive side with respect to the ground line. Alternatively, the fuse and the shunt resistor may be serially connected to each other on the positive or negative side with respect to the ground line.

In the fuse 8 and the shunt resistor 7, a voltage is generated that corresponds to a product a current flowing in the high-voltage battery portion 1 and the electrical resistance of each of the fuse 8 and the shunt resistor 7. In other words, a fuse voltage and a shunt resistor voltage are generated that arise from the current. The fuse 8 and the shunt resistor 7 are connected to the ground line 21. Accordingly, the fuse voltage of the fuse 8 and the shunt resistor voltage of the shunt resistor 7 are voltages with respect to the ground line 21. Even if a battery is connected between the fuse 8 or the shunt resistor 7 and the ground line 21, a voltage difference is generated that corresponds to a voltage drop in the fuse 8 or the shunt resistor 7. However, in the case where the fuse or the shunt resistor is connected to the ground line via the battery, the fuse voltage or the shunt resistor voltage is deviated from the ground line by a voltage corresponding to a voltage of the battery. For example, if a battery of 100 V is connected between the fuse or the shunt resistor and the ground line 21, the fuse voltage of the fuse or the shunt resistor voltage of the shunt resistor will be deviated from the ground line by 100 V. If the generated voltage difference is deviated from the ground line, it is difficult to detect the fuse voltage or the shunt resistor voltage with high accuracy. The reason is that the voltage dividing circuit provides a fraction of the deviated fuse or shunt resistor voltage, and the voltage detecting circuit detects the fraction of the deviated voltage. In the case where the fuse 8 and the shunt resistor 7 are directly connected to the ground line 21, the fuse and the shunt resistor voltages are not deviated from the ground line 21, and can be detected by the voltage detecting circuit 4, 34, or 54 without via a voltage dividing circuit. For this reason, the fuse voltage and the shunt resistor voltage can be detected with high accuracy.

However, if a deviation voltage of the fuse or shunt resistor voltage is small, the fuse or shunt resistor voltage can be provided to the voltage detecting circuit without via a voltage dividing circuit, and can be detected with high accuracy by the voltage detecting circuit. For this reason, the fuse and the shunt resistor may be connected to the ground line via batteries the number of which is not more than one tenth the number of total batteries that compose the battery block, for example. In the case where the fuse or the shunt resistor is connected to the ground line via batteries the number of which is one tenth the number of total batteries of the battery block, for example, with the assumption that the total voltage of the battery block is 110 to 150 V, the deviated voltage will be 11 to 15 V. Accordingly, the fuse voltage or the shunt resistor voltage can be detected by the voltage detecting circuit without a voltage dividing circuit.

In the power supply device shown in FIG. 1, the shunt resistor 7 and the current detecting circuit 6 compose the current detecting portion 3. The current detecting circuit 6 detects the shunt resistor voltage that is generated between the both ends of the shunt resistor 7 by a current flowing in the high-voltage battery portion 1, and detects the current of the high-voltage battery portion 1. In order to detect the shunt resistor voltage, a node 26 between the shunt resistor 7 and a battery 2 is connected to the current detecting circuit 6. The shunt resistor voltage can be represented by a product of the current of the high-voltage battery portion 1 and the electrical resistance of the shunt resistor 7. Thus, the current detecting circuit 6 detects the shunt resistor voltage of the shunt resistor 7, and can detect the current of the high-voltage battery portion 1. The current detecting circuit 6 detects the shunt resistor voltage of the shunt resistor 7, that is, a voltage that is insulated from the vehicle chassis ground. For this reason, the current detecting circuit 6 is provided with power via the power supply line 20 by the insulated-type power supply circuit 5A similarly to the voltage detecting circuit 4. In other words, the insulated-type power supply circuit 5A provides power to the power supply line 20 of each of the voltage detecting circuit 4 and the current detecting circuit 6.

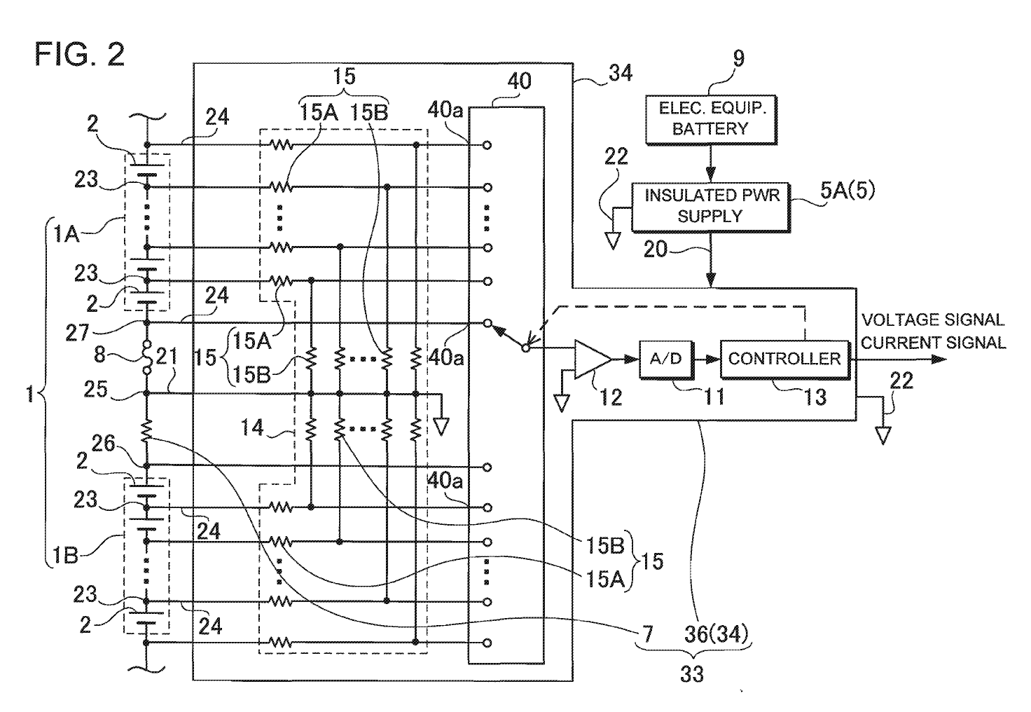

In the power supply device shown in FIG. 2, the current detecting portion 33 is composed of the shunt resistor 7, and the current detecting circuit 36 that detects the current of the high-voltage battery portion 1 based on the shunt resistor voltage of the shunt resistor 7. The current detecting circuit 36 also serves as the voltage detecting circuit 34. In this power supply device, a current detecting circuit is not provided that is dedicated to detection of the current of the shunt resistor 7, the current detecting circuit 36 also serves as the voltage detecting circuit 34. The node 26 between the shunt resistor 7 and the battery 2 is connected to one input terminal 40a of the multiplexer 40 so that the voltage of the shunt resistor 7 is provided to the multiplexer 40. The ground line 21 of the multiplexer 40 is connected to the ground line 21 of the high-voltage battery portion 1. The shunt resistor voltage of the shunt resistor 7 is provided to the multiplexer 40, and is provided to the A/D converter 11 via the multiplexer 40. Thus, the shunt resistor voltage is detected as a voltage signal in digital form. The voltage of the shunt resistor 7 is directly provided to the multiplexer 40. The voltage of the shunt resistor 7 may be amplified by an input amplifier and be then provided to the multiplexer. In the case of the current detecting portion where the shunt resistor voltage is amplified by the input amplifier, and is then provided to the multiplexer, the electrical resistance of the shunt resistor can be small, and the shunt resistor voltage can be small that arises from to the current. Therefore, it is possible to reduce the loss and heat generation caused by the shunt resistor.

The multiplexer 40 provides switching of the input terminals 40a at the predetermined sampling period to provide the A/D converter 11 with the voltages of the batteries and the shunt resistor voltage that is provided from the shunt resistor 7. The A/D converter 11 converts the shunt resistor voltage in analog form that is provided from the multiplexer 10 into digital form. The current of the high-voltage battery portion 1 is detected based on the shunt resistor voltage in digital form that is provided from the A/D converter 11. The shunt resistor voltage can be represented by a product of the current of the high-voltage battery portion 1 and the electrical resistance of the shunt resistor 7. Accordingly, the current of the high-voltage battery portion 1 can be obtained by calculation of (shunt resistor voltage)/(electrical resistance).

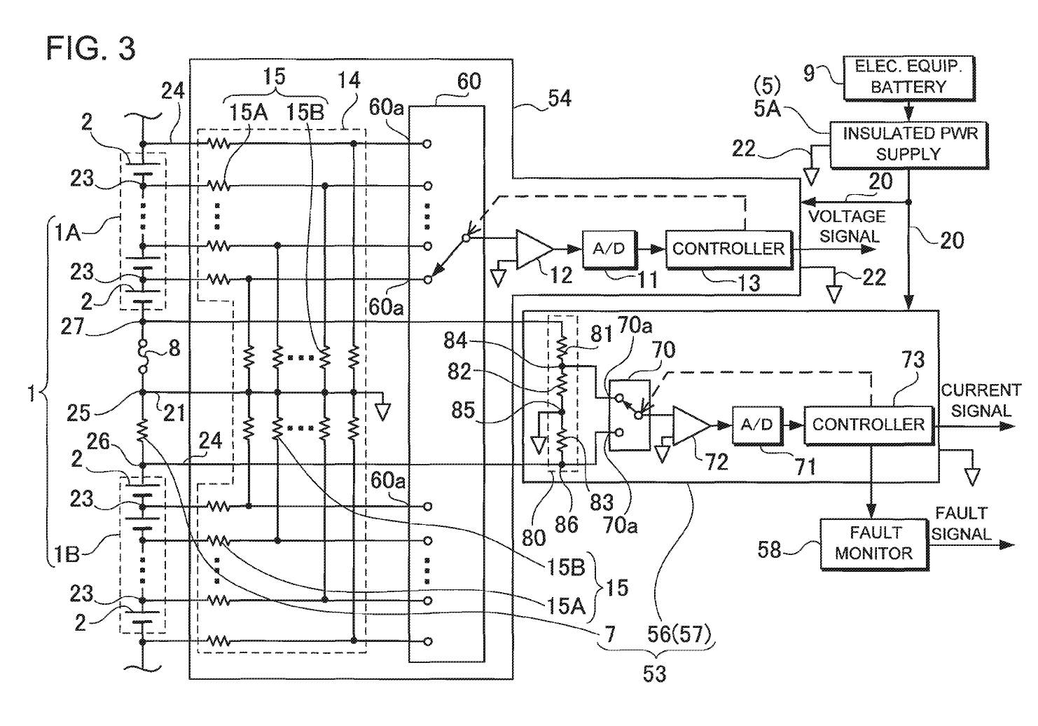

In the power supply device shown in FIG. 3, the current detecting portion 53 is composed of the shunt resistor 7, and the current detecting circuit 56 that detects the current of the high-voltage battery portion 1 based on the shunt resistor voltage of the shunt resistor 7. The illustrated power supply device includes a secondary voltage detecting circuit 57 that detects the voltage between the both ends of each of the shunt resistor 7 and the fuse 8. This secondary voltage detecting circuit 57 also serves as the current detecting circuit 56 that detects the current of the shunt resistor 7. In the illustrated power supply device, in order to detect the shunt resistor voltage and the fuse voltage, the node 26 between the shunt resistor 7 and the battery 2 is connected to the secondary voltage detecting circuit 57 via the voltage detection line 24, and a node 27 between the fuse 8 and a battery 2 is connected to the secondary voltage detecting circuit 57 via a voltage detection line 24. The illustrated secondary voltage detecting circuit 57 includes a switching circuit 70 that includes a plurality of input terminals 70a. The voltage of the shunt resistor 7 and the voltage of the fuse 8 are provided to the input terminals 70a of the switching circuit 70. The switching circuit 70 provides switching of the input terminals 70a at predetermined timing to provide the shunt resistor voltage and the fuse voltage to an A/D converter 71. The A/D converter 71 converts the shunt resistor voltage in analog form that is provided from the switching circuit 70 into digital form. The current of the high-voltage battery portion 1 is detected based on the shunt resistor voltage in digital form that is provided from the A/D converter 71. The output of the switching circuit 70 is provided to the A/D converter 71 via a buffer amplifier 72. The A/D converter 71 converts the detected voltages into digital signals, and provides the digital signals to a control circuit 73. The control circuit 73 detects the current of the high-voltage battery portion 1 based on the shunt resistor voltage in digital form that is provided from the A/D converter 71, and provides the detected current of the high-voltage battery portion 1. The current of the high-voltage battery portion 1 can be obtained by calculation of (shunt resistor voltage)/(electrical resistance).

In the power supply device shown in FIG. 3, the secondary voltage detecting circuit 57 detects the fuse voltage that is generated between the both ends of the fuse 8, and fault of the fuse 8 and the shunt resistor 7 is monitored based on the fuse voltage and the shunt resistor voltage. The illustrated power supply device includes a fault monitoring circuit 58 that monitors fault of the fuse 8 and the shunt resistor 7 based on the voltages detected by the secondary voltage detecting circuit 57. In order that the fault monitoring circuit 58 may monitor fault of the fuse 8 and the shunt resistor 7, the secondary voltage detecting circuit 57 obtains a fraction of the voltage generated between the both ends of the fuse 8 or the shunt resistor 7, and detects the generated voltage based on the obtained fraction of the generated voltage. In the secondary voltage detecting circuit 57 shown in FIG. 3, an input circuit 80 provides a fraction of the fuse voltage that is generated between the both ends of the fuse 8, and the fraction of the fuse voltage is provided to the switching circuit 70. It should be appreciated that, in the secondary voltage detecting circuit, the input circuit may provides a fraction of the shunt resistor voltage that is generated between both ends of the shunt resistor, and the fraction of the shunt resistor voltage may be provided to the switching circuit. To obtain a fraction of the fuse voltage, in the illustrated input circuit 80, a series circuit of first and second input resistors 81 and 82 is connected to the fuse 8 in parallel. In the input circuit 80, a node 84 between the first and second input resistors 81 and 82 is connected to one of the input terminals 70a of the switching circuit 70, and the obtained fraction of the voltage of the fuse 8 is provided to the switching circuit 70. In the input circuit 80, a third input resistor 83 is connected to the shunt resistor 7 in parallel. The series circuit of the first and second input resistors 81 and 82 is connected to the third input resistor 83 in series. A node 85 between the series circuit and the third input resistor 83 is connected to the ground line 21. A node 86 on the other side of the third input resistor 83 is connected to another input terminal 70a of the switching circuit 70. The voltage of the shunt resistor 7 is provided to the switching circuit 70. The electrical resistances of the input resistors that compose the input circuit 80 are sufficiently large as compared with the electrical resistances of the fuse 8 and the shunt resistor 7 (e.g., not less than 100 times as large as the electrical resistances of the fuse 8 and the shunt resistor 7) so that the shunt resistor voltage can be detected within a small error.

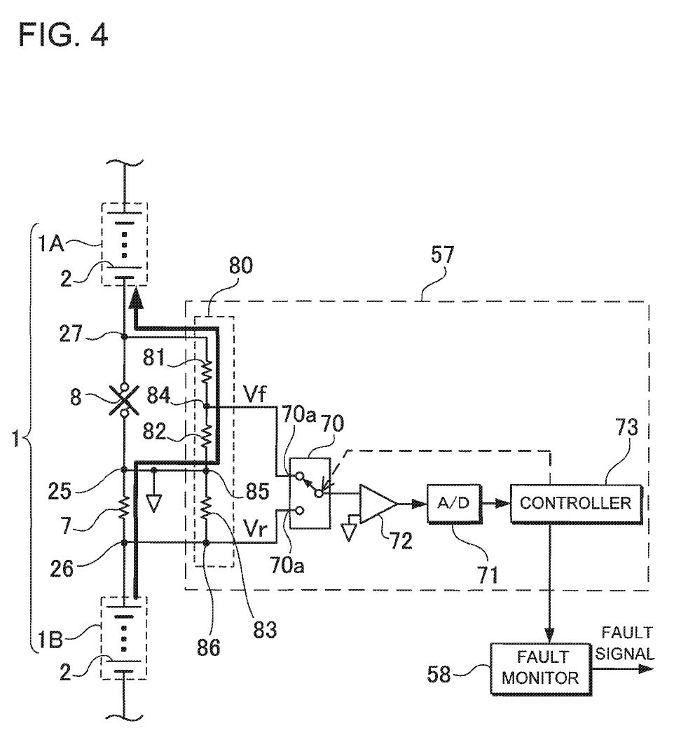

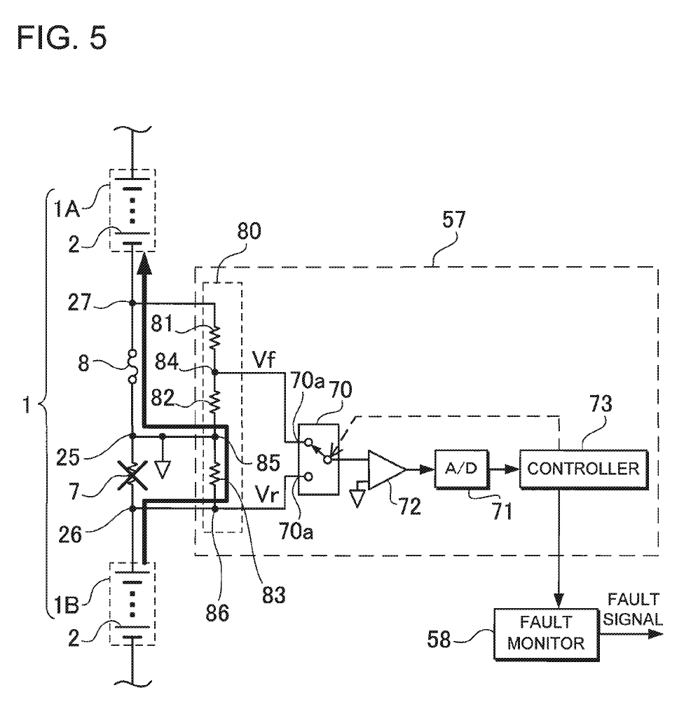

In the thus-configured secondary voltage detecting circuit 57, the shunt resistor and fuse voltages are provided to the switching circuit 70 via the input circuit 80. In the case where the shunt resistor 7 and the fuse 8 are in a proper state, the provided the shunt resistor and fuse voltages fall within predetermined ranges. However, if the shunt resistor 7 or the fuse 8 is disconnected, a current flows in a path shown by an arrow in FIG. 4 or 5, and the shunt resistor voltage or the fuse voltage is detected in a condition of this current flow.

FIG. 4 shows the path of the current in the case where the fuse 8 is disconnected. In this case, a voltage equal to the total voltage Vtotal of the high-voltage battery portion 1 is applied to the series circuit of the first and second input resistors 81 and 82. Accordingly, the input circuit 80 provides a fraction of the total voltage Vtotal to the switching circuit 70 as a voltage Vf of the node 84 between the first and second input resistors 81 and 82. Thus, the fraction of the total voltage Vtotal is detected as the voltage Vf. That is,

Vf=Vtotal×R2/(R1+R2)

where R1 is the electrical resistance of the first input resistor 81, and R2 is the electrical resistance of the second input resistor 82.

If the electrical resistances R1 and R2 of the first and second resistor 81 and 82 are equal, the voltage Vf can be detected by Vf=Vtotal/2. If the secondary voltage detecting circuit 57 detects that the voltage Vf to be detected as a fraction of the fuse voltage is one half of the total voltage Vtotal, the fault monitoring circuit 58 determines that the fuse 8 is disconnected, and provides a fault signal.

FIG. 5 shows the path of the current in the case where the shunt resistor 7 is disconnected. In this case, a voltage equal to the total voltage Vtotal of the high-voltage battery portion 1 is applied to the third input resistor 83. Accordingly, the total voltage Vtotal is provided to the switching circuit 70 as a voltage Vr of the node 86 between the third input resistor 83 and the shunt resistor 7. If the secondary voltage detecting circuit 57 detects that the voltage Vr to be detected as the shunt resistor voltage is equal to the total voltage Vtotal, the fault monitoring circuit 58 determines that the shunt resistor 7 is disconnected, and provides a fault signal.

Also, the fault monitoring circuit 58 can detect, based on the shunt resistor voltage and the fuse voltage detected by the secondary voltage detecting circuit 57, whether the resistance of the shunt resistor 7 is improper. In the secondary voltage detecting circuit 57, the detection voltages Vr and Vf to be detected as the shunt resistor and fuse voltages fall within predetermined voltage ranges in the case where the shunt resistor 7 and the fuse 8 are in a proper state. For this reason, if the difference between Vr and Vf does not fall within a predetermined range, it can be determined that the resistance of the shunt resistor 7 is improper. If the difference between the detection voltages Vr and Vf detected by the secondary voltage detecting circuit 57 does not fall within the predetermined range, the fault monitoring circuit 58 determines that the resistance of the shunt resistor 7 is improper, and provides a fault signal.

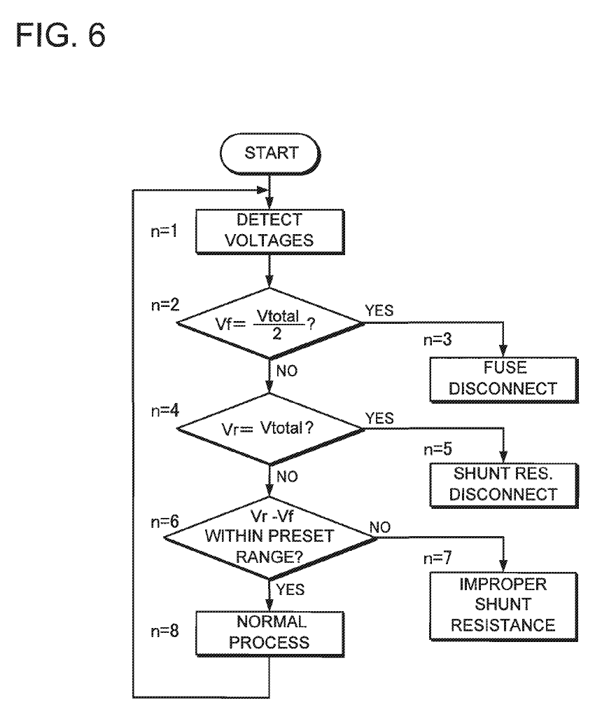

The following description will describe fault monitoring of the fuse 8 and the shunt resistor 7 by the fault monitoring circuit 58 with reference to a flowchart shown in FIG. 6. The following description describes monitoring with reference to the flowchart in the case where the electrical resistances R1 and R2 of the first and second input resistors 81 and 82 of the input circuit 80 are equal to each other.

(Step n=1)

The secondary voltage detecting circuit 57 detects the voltages Vr and Vf of the nodes 86 and 84 of as the shunt resistor and fuse voltages, respectively.

(Steps n=2 and 3)

In Steps 2 and 3, it is determined whether the fuse 8 is disconnected. The fault monitoring circuit 58 determines whether the voltage Vf detected by the secondary detecting circuit 57 is equal to one half of the total voltage Vtotal. The total voltage Vtotal to be used for the determination can be a voltage value that is previously stored as the total voltage of the high-voltage battery portion 1. Alternatively, the total voltage that is detected by the voltage detecting circuit 54 can be provided as the total voltage Vtotal to be used for the determination. If the voltage Vf is equal to Vtotal/2, it is determined that the fuse 8 is disconnected, and a fault signal is provided.

(Steps n=4 and 5)

If it is not determined that the fuse is disconnected, in Steps n=4 and 5, it is determined whether the shunt resistor 7 is disconnected. The fault monitoring circuit 58 determines whether the voltage Vr detected by the secondary detecting circuit 57 is equal to of the total voltage Vtotal. If the voltage Vr is equal to the total voltage Vtotal, it is determined that the shunt resistor 7 is disconnected, and a fault signal is provided.

(Steps n=6 and 7)

Also, if it is not determined that the shunt resistor 7 is disconnected, in Steps n=6 and 7, it is determined whether the resistance of the shunt resistor 7 is improper. The fault monitoring circuit 58 calculates the difference between the voltages Vr and Vf that are detected by the secondary detecting circuit 57, and determines whether this difference falls within a predetermined range. If the difference between the voltages Vr and Vf does not fall within the predetermined range, it is determined that the resistance of the shunt resistor 7 is improper, and a fault signal is provided.

(Step n=8)

If the difference between the voltages Vr and Vf falls within the predetermined range, it is determined that the resistance of the shunt resistor 7 is proper, and a normal process is conducted. After the normal process, the procedure returns to Step n=1.

If the fault monitoring circuit 58 detects fault or an improper state of the fuse 8 or the shunt resistor 7 in the aforementioned procedure, the power supply device turns a contactor OFF so that power is not supplied from the high-voltage battery portion 1 to the vehicles side. Alternatively, the power supply device restricts power supplied from the high-voltage battery portion 1 to ensure safety.

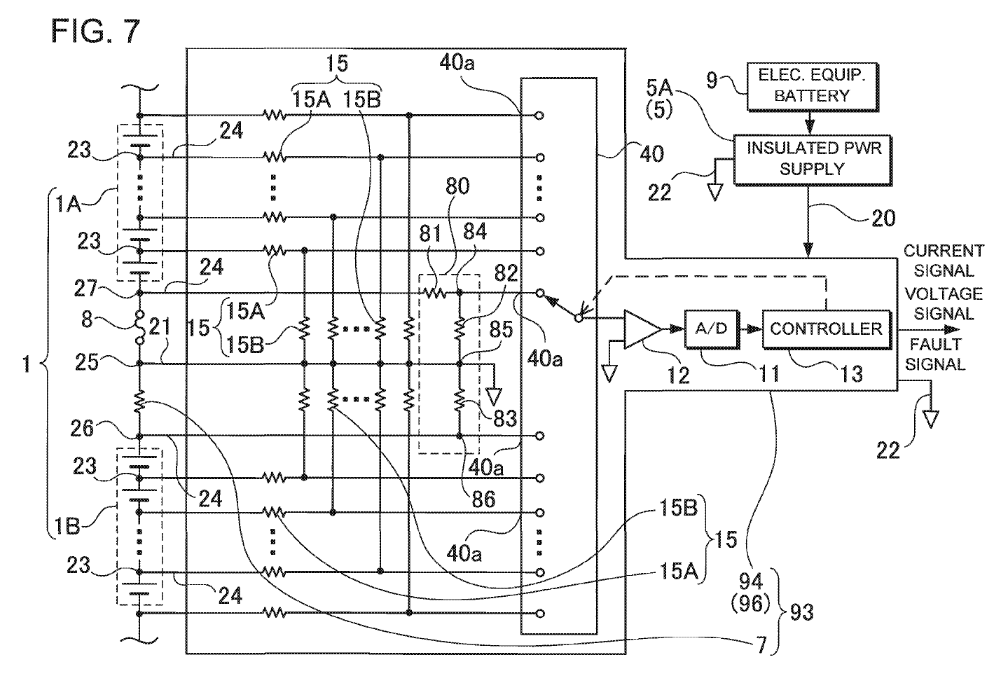

Also, in the power supply device, the secondary voltage detecting circuit can detect the fuse voltage and the shunt resistor voltage to monitor fault of the fuse and the shunt resistor, and additionally can serve as the voltage detecting circuit. In a power supply device shown FIG. 7, a voltage detecting circuit 94 detects the shunt resistor voltage of the shunt resistor 7 and the fuse voltage of the fuse 8, and additionally serves as the voltage detecting circuit that detects the voltage of the battery. In this power supply device, the current detecting portion 93 is composed of the shunt resistor 7, and the current detecting circuit 96 that detects the current of the high-voltage battery portion 1 based on the shunt resistor voltage of the shunt resistor 7. The current detecting circuit 96 also serves as the voltage detecting circuit 94. This power supply device does not include a secondary voltage detecting circuit that is dedicated to detection of the shunt resistor voltage and the fuse voltage. This power supply device monitors fault of the shunt resistor 7 and the fuse 8 based on the shunt resistor voltage and the fuse voltage that are detected by the voltage detecting circuit 94.

In the voltage detecting circuit 94 of the power supply device shown in FIG. 7, the multiplexer 40 is connected via the input circuit 80 to voltage detection lines 24 that detect the fuse and shunt resistor voltages that are generated between the both ends of the fuse 8 and between the both ends of the shunt resistor 7. In the secondary voltage detecting circuit 94, similar to the aforementioned secondary voltage detecting circuit, the input circuit 80 provides a fraction of the fuse voltage that is generated between the both ends of the fuse 8, and the fraction of fraction of the fuse voltage is provided to the multiplexer 40. To obtain a fraction of the fuse voltage, the series circuit of the first and second input resistor 81 and 82 is connected to the fuse 8 in parallel. The third input resistor 83 is connected to the shunt resistor 7 in parallel. In the voltage detecting circuit 94, the multiplexer 40 provides switching of the input terminals 40a at the predetermined sampling period to provide the A/D converter 11 with the voltages of the batteries, the shunt resistor voltage and the fuse voltage. The A/D converter 11 converts analog signals that are provided from the multiplexer 40 into digital signals. The control circuit 13 detects the current of the high-voltage battery portion 1 based on the shunt resistor voltage, and provides the detected current. That is, this voltage detecting circuit 94 also serves as the current detecting circuit 96 that detects the current of the high-voltage battery portion 1. The control circuit 13 provides the detected shunt resistor and fuse voltages to the fault monitoring circuit 58. The fault monitoring circuit 58 monitors fault or an improper state of the shunt resistor 7 and the fuse 8 based on the shunt resistor voltage and the fuse voltage that are provided from the voltage detecting circuit 94 as shown in the flowchart of FIG. 6.

In the power supply devices shown in FIG. 3 and FIG. 7, the shunt resistor voltage and the fuse voltage are detected via the input circuit 80. The shunt resistor voltage is generated between the both ends of the shunt resistor 7. The fuse voltage is generated between the both ends of the fuse 8. A fraction of the fuse voltage is obtained by the input circuit 80, and is then detected. Fault of the shunt resistor 7 and the fuse 8 is monitored based on the detected fraction of the fuse voltage. However, the power supply device does not necessarily include the input circuit. It should be appreciated that the power supply device may monitor fault of the shunt resistor and the fuse without obtaining a fraction of the shunt resistor voltage or the fuse voltage by a voltage divider. For example, in the power supply device shown in FIG. 1, if the shunt resistor voltage provided to the current detecting circuit 6 is larger than a predetermined voltage, it can be determined that the shunt resistor 7 is disconnected or that the resistance of the shunt resistor 7 is improper. Also, if the voltage of the node 27 between the fuse 8 and a battery 2 is larger than a predetermined voltage, it can be determined that the fuse 8 is disconnected or in an improper state. The voltage of the node 27 between the fuse 8 and the battery 2 is detected by the voltage detecting circuit 4 at a point where the contact of the multiplexer 10 is switched to an input terminal 10a that is connected to the node 27 between the fuse 8 and the battery 2. Also, in the power supply device shown in FIG. 2, if the voltage of the node 26 between the shunt resistor 7 and a battery 2 is larger than a predetermined voltage, it can be determined the shunt resistor 7 is disconnected or that the resistance of the shunt resistor 7 is improper. The voltage of the node 26 between the shunt resistor 7 and the battery 2 is detected by the voltage detecting circuit 34 at a point where the contact of the multiplexer 40 is switched to an input terminal 40a that is connected to the node 26 between the shunt resistor 7 and the battery 2. Also, if the voltage of the node 27 between the fuse 8 and a battery 2 is larger than a predetermined voltage, it can be determined that the fuse 8 is disconnected or in an improper state. The voltage of the node 27 between the fuse 8 and the battery 2 is detected at a point where the contact of the multiplexer 40 is switched to an input terminal 40a that is connected to the node 27 between the fuse 8 and the battery 2.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2008-141703 filed in Japan on May 29, 2008, the content of which is incorporated herein by reference.

What is claimed is:

1. A vehicle power supply device comprising:
a high-voltage battery portion that includes a plurality of serially-connected rechargeable batteries;
a current detecting portion that detects the current of the high-voltage battery portion;
a voltage detecting circuit that detects the voltage of the high-voltage battery portion; and
a power supply circuit that supplies power to power supply lines of the voltage detecting circuit and the current detecting portion, wherein said current detecting portion further comprising
a shunt resistor that is serially connected to the batteries, and
a current detecting circuit that detects the current based on the voltage between the both ends of the shunt resistor, wherein
said power supply circuit is an insulated-type power supply circuit that is insulated from a vehicle chassis ground and supplies power, and the insulated-type power supply circuit supplies the power to the power supply lines of both the current detecting circuit and the voltage detecting circuit.

2. The vehicle power supply device according to claim 1, wherein said insulated-type power supply circuit includes an insulated transformer that supplies power supplied from an electrical equipment battery to the power supply lines of the voltage detecting circuit.

3. The vehicle power supply device according to claim 2, wherein said insulated-type power supply circuit stabilizes the voltage of the electrical equipment battery and supplies the stabilized power to the power supply lines of the voltage detecting circuit.

4. The vehicle power supply device according to claim 1, wherein said insulated-type power supply circuit supplies the power from said high-voltage battery portion.

5. The vehicle power supply device according to claim 1, wherein said voltage detecting circuit detects the voltage of the high-voltage battery portion, and controls charging/discharging operation of the high-voltage battery portion based on the detected voltage.

6. The vehicle power supply device according to claim 1, wherein the high-voltage battery portion includes a plurality of serially-connected battery modules each of which is composed of two or more of the serially-connected rechargeable batteries, and said voltage detecting circuit detects the voltage of each battery module.

7. The vehicle power supply device according to claim 1, wherein said voltage detecting circuit detects the voltage of each battery.

8. The vehicle power supply device according to claim 1, wherein said high-voltage battery portion is insulated from the chassis ground, and includes two battery blocks that are connected on the positive and negative sides with respect to a ground line connected to an earth line of the insulated-type power supply circuit, wherein said shunt resistor is serially connected to a point in proximity to the ground line.

9. The vehicle power supply device according to claim 8, wherein said high-voltage battery portion is insulated from the chassis ground, and includes the two battery blocks that are connected on the positive and negative sides with respect to the ground line connected to the earth line of the insulated-type power supply circuit, wherein said shunt resistor is connected to the ground line.

10. The vehicle power supply device according to claim 1 further comprising a fuse that is serially connected to said high-voltage battery portion, wherein said high-voltage battery portion is insulated from the chassis ground, and includes two battery blocks that are connected on the positive and negative sides with respect to a ground line connected to an earth line of the insulated-type power supply circuit, wherein said fuse is serially connected to a point in proximity to the ground line.

11. The vehicle power supply device according to claim 1 further comprising a fuse that is serially connected to said high-voltage battery portion, wherein said high-voltage battery portion is insulated from the chassis ground, and includes two battery blocks that are connected on the positive and negative sides with respect to a ground line connected to an earth line of the insulated-type power supply circuit, wherein said fuse is serially connected to the ground line.

12. The vehicle power supply device according to claim 10, wherein the two battery blocks of said high-voltage battery portion are serially connected to each other via a series circuit of said fuse and said shunt resistor.

13. The vehicle power supply device according to claim 11, wherein a node between said fuse and said shunt resistor is connected to the ground line of the insulated-type power supply circuit.

14. The vehicle power supply device according to claim 13, wherein said fuse is connected on the positive side with respect to the ground line 21, and the shunt resistor is connected on the negative side with respect to the ground line.

15. The vehicle power supply device according to claim 1, wherein said voltage detecting circuit comprises
a multiplexer that includes a plurality of input terminals connected to the plurality of batteries, and provides switching of the input terminals at a predetermined sampling period to detect the voltages of the batteries, and
an A/D converter that converts analog signals provided from the multiplexer into digital signals, and provides the voltages of the batteries represented by the digital signals, wherein
the channel number of input terminals of said multiplexer is greater than the number of the input terminals that detects the voltages of the batteries, wherein the shunt resistor is connected to one of the input terminals of the multiplexer, wherein the multiplexer provides switching of the input terminals that are connected to the batteries and the shunt resistor to provide the voltages of the batteries and the voltage of the shunt resistor to the A/D converter so that the voltages and the currents of the batteries are detected based on the outputs of the A/D converter.

16. The vehicle power supply device according to claim 15, wherein a ground line of said multiplexer is connected to a ground line of the high-voltage battery portion.

17. The vehicle power supply device according to claim 15 further comprising a buffer amplifier that is connected between the output side of said multiplexer and the A/D converter, wherein the output of the multiplexer is provided to the A/D converter via the buffer amplifier.

18. The vehicle power supply device according to claim 1 further comprising
a secondary voltage detecting circuit that detects the voltages between the both ends of said fuse and between the both ends of the shunt resistor, and
a fault monitoring circuit that monitors fault of the fuse and the shunt resistor based on the voltages detected by the secondary voltage detecting circuit.

19. The vehicle power supply device according to claim 18, wherein said secondary voltage detecting circuit detects one of the voltages generated between the both ends of the fuse and between the both ends of the shunt resistor, and the fault monitoring circuit monitors fault of the fuse and the shunt resistor based on the detected one of the voltages.

20. The vehicle power supply device according to claim 18, wherein said secondary voltage detecting circuit detects a fraction of one of the voltages generated between the both ends of the fuse and between the both ends of the shunt resistor, and the fault monitoring circuit monitors fault of the fuse and the shunt resistor based on the detected fraction of the voltage.
